(19) United States
(12) Patent Application Publication
(10) Pub. No.: US 2015/0084221 A1
(43) Pub. Date: Mar. 26, 2015

(54) INJECTION MOLDING MACHINE WITH VISCOSITY MEASURING FUNCTION AND METHOD FOR MEASURING VISCOSITY USING INJECTION MOLDING MACHINE

(71) Applicant: FANUC Corporation, Yamanashi (JP)

(72) Inventor: Akira OOMORI, Yamanashi (JP)

(21) Appl. No.: 14/484,340

(22) Filed: Sep. 12, 2014

(30) Foreign Application Priority Data
Sep. 26, 2013 (JP) 2013-200622

(51) Int. Cl. B29C 45/76; B29C 45/27; B29C 45/77

(52) U.S. Cl. CPC B29C 45/7646; B29C 45/77; B29C 45/2701; B29C 2045/2722; B29C 2945/76006; B29C 2945/7621; B29C 2945/7605; B29C 2945/76381
USPC 264/40.1; 425/568

(57) ABSTRACT

A nozzle is attached to a heating cylinder via a nozzle adapter. A sensor for pressure measurement is attached to the nozzle adapter. A molten resin is injected into the air with a front of the nozzle open, and a resin pressure is measured by pressure measuring unit while the molten resin is being injected into the air. Based on the resin pressure, the viscosity of the injected molten resin is determined.

### BACKGROUND OF THE INVENTION

1. Field of the Invention

The present invention relates to an injection molding machine that measures the viscosity of an injected molten resin and a method for measuring viscosity using the injection molding machine.

2. Description of the Related Art

In injection molding, the viscosity of a molten resin is an important factor that, for example, allows moldability to be determined or allows differences in characteristics among lots to be checked. In general, a dedicated viscosity measuring apparatus such as a capillary rheometer or a melt indexer is used to measure viscosity.

In contrast, various methods for measuring viscosity have been proposed utilizing an injection molding machine in order to “easily achieve measurement” or “measure viscosity in a state similar to a state in which molding is being actually performed”. Japanese Patent Application Laid-open No. 2011-240631 and Japanese Patent Application Laid-open No. H6-166068 describe methods involving attaching, to the apparatus, a mold for viscosity measurement including a pore through which a molten resin flows, a pressure sensor and a temperature sensor, and the like and injecting a resin into the mold to allow the viscosity of the resin to be calculated. Japanese Patent Application Laid-open No. 2004-142204 describes a method for calculating the viscosity without addition of sensors and the like to the injection molding machine.

In the method proposed in Japanese Patent Application Laid-open No. H5-329864, two pressure sensors are installed in a nozzle at respective positions to allow the viscosity to be calculated based on a difference in pressure between an upstream side and a downstream side of the molten resin. Moreover, Japanese Patent Application Laid-open No. H11-10693 discloses a method in which a single pressure sensor is provided and the viscosity is calculated by using atmospheric pressure as the downstream side pressure. Furthermore, Japanese Patent Application Laid-open No. 2002-331558 contains the description that a resin pressure used to evaluate the flow characteristics of a resin may be a pressure measured by a “pressure sensor provided at a tip of a cylinder or on a nozzle portion”.

Relevant non-patent documents include Hideyuki Sasaki and one other, “Viscosity Measurement of Polymer Melts by High-shear Rheometer”, [online], Iwate Industrial Research Institute Research Report Volume 9 (2002), [retrieved on Aug. 20, 2013], Internet<URL:http://www.pref.iwate.jp/-kiri/infor/theme/2001/p df/H13-48-capiro.pdf>. The research report by Sasaki et al., a non-patent document, discloses a method of attaching a dedicated member to a tip of a cylinder to allow viscosity to be calculated. Specifically, the dedicated member includes a member having a small tube, referred to as “capillary”, and a member to which a pressure sensor is attached to measure the resin pressure of a resin flowing into the capillary.

The techniques disclosed in Japanese Patent Application Laid-open No. 2011-240631 and Japanese Patent Application Laid-open No. H6-166068 need to provide a mold dedicated to viscosity calculation besides a mold for production. The method proposed in Japanese Patent Application Laid-open No. 2004-142204 uses the diameter and length of a nozzle hole as a shape used for viscosity calculation, while using a load cell pressure acting to push a screw, for pressure measurement. Thus, the measured pressure includes the resistance of a resin filled in the cylinder during a flight in which the screw moves through the cylinder, and is thus expected to be different from the resin pressure measured when the resin flows into the nozzle hole. That is, the viscosity calculated using the measured pressure is also different from the actual melt viscosity of the resin injected through the nozzle.

The method disclosed in Japanese Patent Application Laid-open No. H5-329864 uses a nozzle longer than the nozzle in the above-described methods by a length corresponding to a channel for viscosity measurement. A resultant pressure drop may degrade moldability. The method disclosed in Japanese Patent Application Laid-open No. H11-10693 uses a pressure measured when a tip portion of the resin reaches a tip portion of the nozzle while the resin is being injected and filled into the mold during molding, and is thus expected to need another certain sensor to detect the corresponding timing. The method disclosed in Japanese Patent Application Laid-open No. H11-10693 is also expected to achieve only a low repetitive accuracy due to the use of an instantaneous pressure that rises rapidly.

In the technique disclosed in Japanese Patent Application Laid-open No. 2002-331558, when the pressure sensor is attached to the tip of the cylinder, the measurement contains a pressure drop resulting from a decrease in the size of a resin channel in conjunction with a shift from the inner diameter of the cylinder to the inner diameter of the cylinder. This is an error factor against more accurate calculation of the resin viscosity. To allow the viscosity to be accurately calculated, a pressure sensor is desirably provided near the tip portion of the nozzle. On the other hand, the nozzle needs to have the shape of the tip portion thereof and the like changed in association with the mold. Attaching a pressure sensor to all the nozzles is expensive, and much time and effort is needed to perform removal and installation of a pressure sensor each time the nozzle is replaced.

The measurement apparatus described in the research report by Sasaki et al., a non-patent document, includes no clamping mechanism but a member for viscosity measurement attached to the measurement apparatus and is not formed to actually allow injection molding. Furthermore, the molten resin channel is bent through 90 degrees, and a pressure sensor is further provided in a corner of the molten resin channel. Thus, the measured resin pressure may be different from a resin pressure measured in apart of the channel where the resin flows straight.

### SUMMARY OF THE INVENTION

With the foregoing in view, it is an object of the present invention to provide an injection molding machine that enables the viscosity of a resin injected through a nozzle to be measured by measuring a pressure in a nozzle adapter that need not be replaced in association with a mold, and a method for measuring viscosity.

To accomplish the object, the present invention uses a nozzle adapter attached between a tip of a heating cylinder and a nozzle to provide a molten resin channel that connects the cylinder to a nozzle, the nozzle adapter including a pressure sensor installed on the nozzle adapter to measure a resin pressure, wherein viscosity of a molten resin is determined using a pressure measured by the pressure sensor installed on the nozzle adapter when a resin is injected into air with a front of the nozzle open. Furthermore, for a pressure measurement position in the nozzle adapter, the pressure can be measured with a pressure drop error resulting from a flow of the molten resin reduced when the pressure measurement is performed in a cylindrical portion which has a diameter equal to an inner diameter of a nozzle-side end surface of the nozzle adapter.

An injection molding machine according to the present invention configured to melt a resin in a heating cylinder and then move a screw or a plunger forward to inject the molten resin through a nozzle, and includes a nozzle adapter attached between a tip portion of the heating cylinder and the nozzle to provide a molten resin channel that connects the heating cylinder to the nozzle, a pressure measuring unit configured to measure a resin pressure in the nozzle adapter, and a molten resin injecting unit configured to inject the molten resin into air with a front of the nozzle open. The injection molding machine further includes a viscosity determining unit configured to determine viscosity of the injected molten resin based on the resin pressure measured by the pressure measuring unit while the molten resin injecting unit is injecting the molten resin into the air.

A resin pressure measurement position in the nozzle adapter may be a position closer to the nozzle than an axial position that is closest to the nozzle, among axial positions where the molten resin channel has a diameter equal to an inner diameter of a heating cylinder-side end surface.

A pressure measurement position in the nozzle adapter may be a cylindrical portion, of the molten resin channel, which has an inner diameter equal to an inner diameter of a nozzle-side end surface.

The injection molding machine may include a storing unit configured to store a hole diameter and a length of a tube portion at a nozzle tip and a diameter of the screw or the plunger, and the viscosity determining unit is configured to determine viscosity may determine the viscosity from the resin pressure measured at a set screw position or at a set elapsed time since start of injection, an injection speed, and the stored hole diameter and length of the tube portion at the nozzle tip and the stored diameter of the screw or the plunger. Moreover, the injection molding machine may save information on combination of the hole diameter and the length of the tube portion at the nozzle tip to a database as nozzle shape data, and the viscosity may be determined by reading the information on the hole diameter and the length of the tube portion at the nozzle tip based on the attached nozzle.

A method for measuring resin viscosity according to the present invention uses an injection molding machine configured to melt a resin in a heating cylinder and then move a screw or a plunger forward to inject the molten resin through a nozzle. The method comprises: measuring the resin pressure when the molten resin is injected into air with a front of the nozzle open, using pressure measuring unit configured to measure a resin pressure in a nozzle adapter attached between a tip portion of the heating cylinder and the nozzle to provide a molten resin channel that connects the heating cylinder to the nozzle; and determining viscosity of the injected molten resin based on the measured resin pressure.

A resin pressure measurement position in the nozzle adapter may be a position closer to the nozzle than an axial position that is closest to the nozzle, among axial positions where the molten resin channel has a diameter equal to an inner diameter of a heating cylinder-side end surface.

A pressure measurement position in the nozzle adapter may be a cylindrical portion, of the molten resin channel, which has an inner diameter equal to an inner diameter of a nozzle-side end surface.

The method for measuring the resin viscosity may determine the viscosity from the resin pressure measured at a set screw position or at a set elapsed time since start of injection, an injection speed, a hole diameter and a length of a tube portion at a nozzle tip, and a diameter of a screw or a plunger.

The present invention is configured as described above and can thus provide an injection molding machine that enables the viscosity of a resin injected through a nozzle to be measured by measuring the pressure in a nozzle adapter that need not be replaced in association with a mold, and a method for measuring viscosity.

### BRIEF DESCRIPTION OF THE DRAWINGS

The above-described and other objects and features of the present invention will be apparent from the description of embodiments taken with reference to the attached drawings.

FIG. 1 is a diagram illustrating an embodiment of the present invention in which a nozzle is attached to a heating cylinder via a nozzle adapter;

FIG. 2 is a diagram illustrating a pressure measurement position;

FIG. 3 is a diagram illustrating a pressure measurement position; and

FIG. 4 is a block diagram illustrating a configuration of an injection molding machine.

### DESCRIPTION OF THE PREFERRED EMBODIMENTS

One embodiment of the present invention is applicable to an injection molding machine that injects a molten resin through a nozzle by moving a screw or a plunger forward. The description takes, as an example, an injection molding machine that injects a molten resin through a nozzle by moving a screw forward.

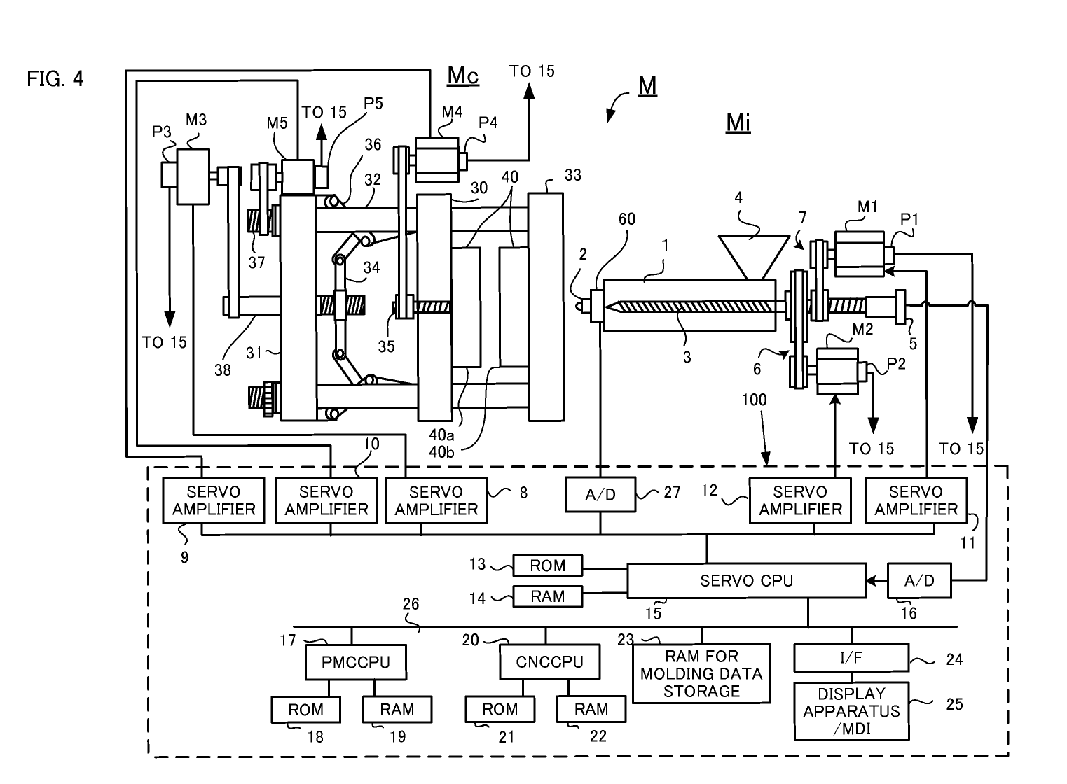

As shown in FIG. 4, an injection molding machine M includes a clamping section Mc and an injection section Mi both provided on a machine base. The injection section Mi heats and melts a resin material, in other words, a pellet, in a heating cylinder 1 and injects the molten resin into a cavity in a mold 40. The clamping section Mc principally opens and closes the mold 40 (40a and 40b). A configuration of the injection molding machine M will be described below.

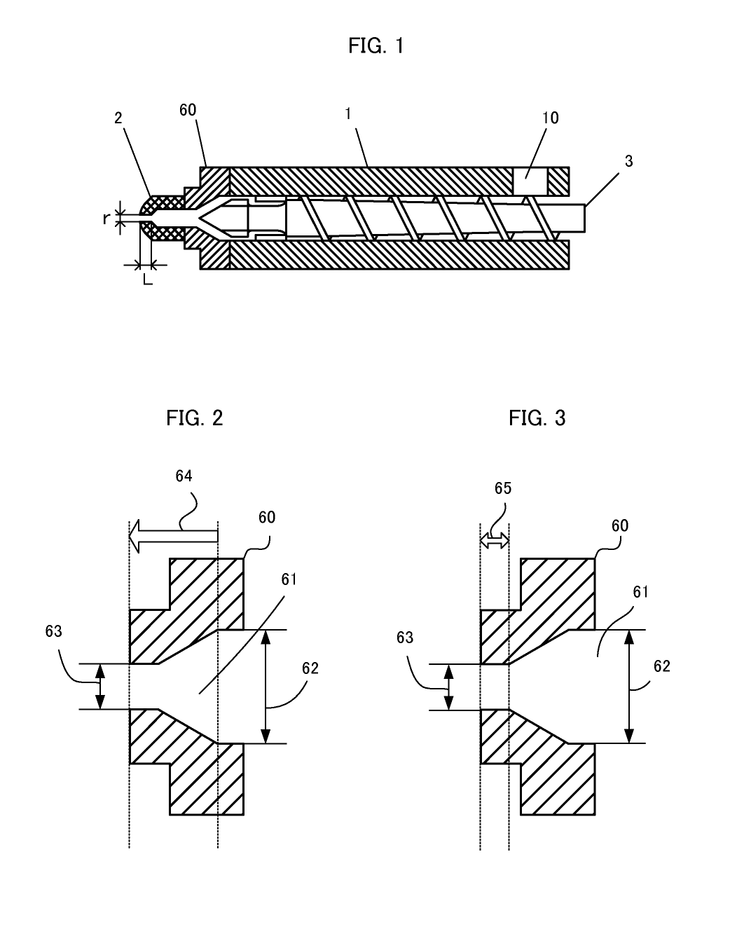

FIG. 1 is a diagram illustrating an embodiment in which a nozzle 2 is attached to the heating cylinder 1 via a nozzle adapter 60. FIG. 2 is a diagram illustrating a pressure measurement position 64. FIG. 3 is a diagram illustrating a pressure measurement position 65.

To measure a resin pressure in order to determine viscosity, measurement is desirably performed near a nozzle tip portion the geometries of which can be used to calculate the viscosity from the standpoint of measurement accuracy. However, for convenience, the nozzle 2 needs to be changed in association with a mold 40 as shown in FIG. 4. Thus, when measurement is performed near the nozzle tip portion, a sensor for pressure measurement needs to be replaced or removed and reinstalled along with the nozzle 2. When a sensor for pressure measurement is attached to the nozzle adapter 60 to measure the pressure, the sensor for pressure measurement need not be replaced or removed and reinstalled along with the nozzle 2.

FIG. 2 is a diagram showing the pressure measurement position 64, and illustrates a cross section of the nozzle adapter 60 taken across a plane containing the major axis of the heating cylinder 1 when the nozzle adapter 60 is attached to the heating cylinder 1. A central portion of the nozzle adapter 60 is a molten resin channel 61, one end of the nozzle adapter 60 is a heating cylinder side, and the other end of the nozzle adapter 60 is a nozzle side. A molten resin flows through the molten resin channel 61 from the right to left of FIG. 2. The pressure measurement position 64 is an example of a position closer to the nozzle than an axial position that is closest to the nozzle, among axial positions where the molten resin channel 61 has a diameter equal to the inner diameter 62 of a heating cylinder-side end surface.

Generally, the molten resin channel 61 in the nozzle adapter 60 has a cross-sectional area changing in conjunction with a shift from the inner diameter of the heating cylinder to the inner diameter of the nozzle. The resin pressure of the flowing resin changes with the cross-sectional area, and thus a resin pressure close to the resin pressure at the nozzle tip portion is measured. Thus, the pressure is measured on a side of the molten resin channel 61 at least closer to the nozzle than a portion of the molten resin channel 61 which has a diameter equal to the inner diameter of a heating cylinder-side end surface. The pressure measurement position 64 is a portion of the molten resin channel 61 in the nozzle adapter 60 which is closer to the nozzle than an axial position that is closest to the nozzle, among the axial positions where the molten resin channel 61 has a diameter equal to the inner diameter of the heating cylinder-side end surface.

FIG. 3 is a diagram showing a pressure measurement position 65 and in which, in order to measure a resin pressure closer to the resin pressure at the nozzle tip portion than in FIG. 2, the pressure is measured in a cylindrical portion of the molten resin channel 61 which has a diameter equal to the inner diameter of a nozzle-side end surface. The inner diameter of the end surface as used herein refers to the inner diameter measured with a chamfer or a round shape excluded, if any. Furthermore, the “equal diameters” include not only actually equal diameters but also, for example, diameters that are designed to be equal but that are actually different from each other as a result of an error in the manufacturing processes. The pressure measurement position 65 is an example of a cylindrical portion, of the molten resin channel 61, which has an inner diameter equal to the inner diameter 63 of the nozzle-side end surface.

FIG. 2 and FIG. 3 show, by way of example, that the inner diameter of the heating cylinder-side end surface is smaller than the inner diameter of the nozzle-side end surface. However, the present invention is not limited to this structure. The inner diameter of the heating cylinder-side end surface may be equal to the inner diameter of the nozzle-side end surface or the inner diameter of the nozzle-side end surface may be larger than the inner diameter of the heating cylinder-side end surface. Furthermore, when the inner diameter of the heating cylinder-side end surface is equal to the inner diameter of the nozzle-side end surface, all positions where the molten resin channel has a diameter equal to the inner diameter of the nozzle-side end surface are included in the “position closer to the nozzle than an axial position that is closest to the nozzle, among the axial positions where the molten resin channel has a diameter equal to the inner diameter of the heating cylinder-side end surface”.

Now, a method for calculating viscosity will be described. The viscosity calculation uses a general formula used in capillary rheometers or the like.

When shear viscosity is denoted by η [Pa·sec], shear stress is denoted by τ [Pa], and shear speed is denoted by γ [sec−1], the shear viscosity η [Pa·sec] is determined using Formula (1), the shear stress τ [Pa] is determined using Formula (2), and the shear speed γ [sec−1] is determined using Formula (3).

$$\begin{matrix}η = \frac{τ}{γ} & ( 1 ) \\ τ = \frac{P \times r}{4 \times L} & ( 2 ) \\ γ = \frac{32 \times Q}{π \times {r}^{3}} & ( 3 )\end{matrix}$$

In these formulae, reference characters represent the following physical quantities:

P: a pressure measured by a pressure sensor installed in the nozzle adapter [Pa];
r: the hole diameter of a tube portion at the nozzle tip [mm];
L: the length of the tube portion at the nozzle tip [mm]; and
Q: flow rate [mm3/sec].

If the molten resin is assumed to move through the heating cylinder and directly out through the nozzle 2, the flow rate Q can be determined by multiplying the cross-sectional area of the screw by the injection speed, that is, the forward speed of the screw. That is, the flow rate Q can be expressed by:

Q=π×R²×v×¼ (4).

In this formula,

R: the diameter of the screw [mm], and
v: the injection speed [mm/sec].

An operation for measuring the viscosity will be described. First, a screw 3 is moved backward while being rotated with the temperature of the heating cylinder 1 controlled to achieve a temperature needed to melt the resin so that the resin material is melted, while a set volume of the molten resin to be injected toward the nozzle side is held in the heating cylinder 1. This is hereinafter sometimes referred to as a metering operation. Then, the screw 3 is moved forward to inject the held molten resin into the air, and the resin pressure at that time is measured to determine the resin viscosity.

However, the resin pressure of the resin from the nozzle 2 is expected to be unstable while the screw is being accelerated after injection is started or immediately after the acceleration. Thus, a pressure is used which is measured when the position of the screw reaches a set screw position or when a set time has elapsed since the start of injection, that is, when the resin pressure of the resin from the nozzle 2 is expected to be stable. An alternative method may be used to detect the resin pressure at a point in time when the resin pressure of the resin from the nozzle 2 is more accurately stable. That is, the injection speed may be detected and the resin pressure at a point in time when the injection speed is stable may be recorded or a variation in resin pressure since the start of injection may be recorded, so that a stabilized resin pressure can be used. As is conventionally well known, a control apparatus for the injection molding machine includes an apparatus that detects the screw position or an apparatus that measures elapsed time since the start of injection as shown in FIG. 4.

Furthermore, actual injection molding in which the molten resin is injected into the mold to obtain a product shape generally uses a method of rotating and moving the screw 3 backward with the molten resin pressurized during a metering operation in order to expel air or any other gas contained in the resin. Viscosity measurement desirably uses the same metering operation as that used to actually obtain a product. However, when the metering operation is performed with the front of the nozzle open as in the case of injection, the molten resin may flow out through the nozzle to preclude sufficient pressurization depending on conditions. In this case, the metering operation can be performed in a pressurized state by applying a member for sealing the nozzle tip to the nozzle tip during the metering operation and separating the member from the nozzle tip during injection. The member for sealing the nozzle tip is attached to, for example, the mold 40 or a fixed platen 33. During the metering operation, the injection section Mi is moved forward to come into abutting contact with the sealing member. After the end of the metering operation, an motor for moving the injection section forward and backward (not shown in the drawings) is driven to move the injection section Mi backward to allow the molten resin to be injected into the air with the front of the nozzle open.

Examples of the pressure sensor that measures the pressure of the molten resin include a type that serves as a direct-pressure pressure sensor to come into direct contact with the molten resin for measurement and a noncontact type which serves as an indirect pressure sensor and which is embedded near a molten resin channel provided in a member such as a strain gauge to measure the resin pressure in the channel based on deformation of the member. However, in the direct pressure type, a step may be formed in the molten resin channel, and a resin retained on the step portion may be carbonized, resulting in inappropriate molding. Thus, as the pressure sensor according to the embodiment, a noncontact pressure sensor, in other words, an indirect pressure sensor, is desirably used.

In the embodiment, the injection molding machine includes the nozzle adapter with the pressure measurement position to melt and inject the resin. The resin pressure measurement itself may be performed by the injection molding machine M or any other equipment such as a personal computer provided that signals from the pressure sensor and the like installed in the nozzle adapter 60 can be processed. Furthermore, the viscosity may be calculated by the injection molding machine M or any other equipment such as a personal computer. In this case, information on the injection molding machine such as the injection speed which is needed for viscosity measurement can be loaded from the injection molding machine into any other equipment such as a personal computer though a network or a storage medium.

FIG. 4 is a diagram illustrating a configuration of an injection molding machine that measures viscosity according to the embodiment. The injection molding machine M includes the clamping section Mc and injection section Mi both provided on the machine base (not shown in the drawings). The injection section Mi heats and melts the resin material, in other words, a pellet, and injects the molten resin into a cavity in the mold 40. The clamping section Mc principally opens and closes the mold 40 (40a and 40b).

First, the injection section Mi will be described. The nozzle 2 is attached to a tip of the heating cylinder 1 via the nozzle adapter 60. The screw 3 is inserted through the heating cylinder 1. The screw 3 includes a resin pressure sensor 5 provided therein and using a load cell or the like which detects the resin pressure based on a pressure applied to the screw 3. An output signal from the resin pressure sensor is converted into a digital signal by an A/D converter 16. The digital signal is input to a servo CPU 15. The pressure sensor (not shown in the drawings) attached to the nozzle adapter 60 to measure the resin pressure detects the resin pressure and provides a resin pressure output signal. The output signal is converted into a digital signal by an A/D converter 27, and the digital signal is input to the servo CPU 15.

The screw 3 is rotated by a servo motor M2 for rotating the screw, via a transmission mechanism 6 including a pulley and a belt. Furthermore, the screw 3 is driven by a servo motor M1 for moving the screw forward and backward, via a transmission mechanism 7 including mechanisms such as a pulley, a belt, and a ball screw/nut mechanism which converts rotational motion into rectilinear motion, to move in the axial direction of the screw 3. Reference numeral P1 denotes a position and speed detector that detects the position and speed of the servo motor M1 for moving the screw forward and backward to detect the axial position and speed of the screw 3. Reference numeral P2 denotes a position and speed detector that detects the position and speed of the servo motor M2 to detect the rotational position and speed around the axis of the screw 3. Reference numeral 4 denotes a hopper that supplies a resin to the heating cylinder 1.

According to the embodiment, the resin pressure is measured by a pressure measuring unit attached to the nozzle adapter 60, and the molten resin is injected into the air with the front of the nozzle 2 open, in other words, with the tip portion of the nozzle 2 not in contact with the fixed mold 40b. Then, based on the resin pressure measured by the pressure measuring unit while the molten resin is being injected into the air, the viscosity of the injected molten resin is determined. A program for calculating the viscosity of the molten resin is stored, for example, in ROM 21. A detection signal from the pressure sensor attached to the nozzle adapter 60 is input to a control apparatus 100. Based on the detection signal from the pressure signal, the control apparatus 100 calculates the value of the viscosity.

Now, the clamping section Mc will be described. The clamping section Mc includes a motor M3 for moving a movable platen 30 forward and backward, a rear platen 31, a motor M4 for moving an ejector forward and backward in order to eject an ejector pin that pushes a mold article out of the mold, the movable platen 30, a tie bar 32, a fixed platen 33, a cross head 34, an ejector mechanism 35, and a toggle mechanism 36.

The rear platen 31 and the fixed platen 33 are coupled together with a plurality of the tie bars 32. The movable platen 30 is arranged so as to be guided by the tie bars 32. The movable mold 40a is attached to the movable platen 30, and the fixed mold 40b is attached to the fixed platen 33. The toggle mechanism 36 can be operated by moving the crosshead 34 forward and backward, which is attached to the ball screw shaft 38 driven by a motor M3 for moving the movable platen forward and backward. In this case, when the cross head 34 is moved forward, in other words, rightward in FIG. 4, the movable platen 30 is moved forward to close the molds. Then, a clamping force, which is obtained by multiplying propulsive force exerted by the motor M3 for moving the movable plate forward and backward by a toggle factor, is generated and clamping is performed using the clamping force.

A motor M5 for adjusting a clamping position is disposed on the rear platen 31. A servo amplifier 10 is connected to the motor M5 for adjusting the clamping position. A rotating shaft of the motor M5 for adjusting the clamping position includes a driving gear (not shown in the drawings) attached to the rotating shaft. A power transmission member such as a toothed belt is passed around a gear of a tie bar nut (not shown in the drawings) and the driving gear. Thus, when the motor M5 for adjusting the clamping position is driven to rotate the driving gear, a tie bar nut fitted over a threaded portion 37 of each of the tie bars 32 in a threaded manner is rotated in synchronism with the driving gear. Thus, the motor M5 for adjusting the clamping position is rotated by a predetermined number of rotations in a predetermined direction to allow the rear platen 31 to move forward or backward by a predetermined distance. The motor M5 for adjusting the clamping position is preferably a servo motor and includes a position detector P5 for rotational-position detection as shown in FIG. 4. A detection signal for the rotational position of the motor M5 for adjusting the clamping position which rotational position is detected by the position detector P5 is input to the servo CPU 15.

The control apparatus 100 for the injection molding machine M has a CNCCPU 20 that is a microprocessor for numerical control, a PMCCPU 17 that is a microprocessor for a programmable machine controller, and a servo CPU 15 that is a microprocessor for servo control. The control apparatus 100 is configured such that, by selecting a mutual input or output via a bus 26, the microprocessors can communicate information to each other.

The servo CPU 15 includes ROM 13 connected thereto and storing a control program dedicated to servo control to execute processing for a position loop, a speed loop, and a current loop, and a RAM 14 also connected thereto and temporarily storing data. Furthermore, the servo CPU 15 is connected via an analog/digital (A/D) converter 16 to the resin pressure sensor 5 provided on a main body side of the injection molding machine to detect various pressures such as an injection pressures so that the servo CPU 15 can detect a pressure signal from the resin pressure sensor 5.

The servo CPU 15 connects to servo amplifiers 11 and 12 that drive, based on instructions from the servo CPU 15, the servomotor M1 for injection, in other words, for moving the screw forward and backward, which is connected to an injection shaft, and the servo motor M2 for rotating the screw, which is connected to a screw rotating shaft. Thus, outputs from the position and speed detectors P1 and P2 connected to the servo motors M1 and M2, respectively, are returned to the servo CPU 15. The rotational positions of the servo motors M1 and M2 are calculated by the servo CPU 15 based on position feedback signals from the position and speed detectors P1 and P2. The rotational positions are stored in respective current position storage registers so as to update old data.

Servo amplifiers 8 and 9 are connected to the servo motor M3 for driving a clamping shaft that clamps the mold and the motor M4 for moving the ejector forward and backward which allows a molded article to be removed from the mold. Outputs from the position and speed detectors P3 and P4 attached to the servo motors M3 and M4, respectively, are returned to the servo CPU 15. The rotational positions of the servo motors M3 and M4 are calculated by the servo CPU 15 based on position feedback signals from the position and speed detectors P3 and P4. The rotational positions are stored in respective current position storage registers so as to update old data.

The PMCCPU 17 connects to ROM 18 storing, for example, a sequence program that controls sequence operations of the injection molding machine and RAM 19 used for, for example, temporary storage of calculation data. The CNCCPU 20 connects to ROM 21 storing various programs such as an automatic operation program that controls the injection molding machine as a whole and a control program that implements a method for setting a clamping force, and RAM 22 used for temporary storage of calculation data.

RAM 23 to which molding data are saved is a nonvolatile memory and stores molding conditions for injection molding operations, various setting values, parameters, macro variables, and the like. In the embodiment of the present invention, the hole diameter and the length of a tube portion at the nozzle tip and the diameter of the screw are input via a display apparatus/manual data input apparatus (MDI) 25 and stored in RAM 23 to which molding data are saved. Alternatively, information on the combination of the hole diameter and the length of the tube portion at the nozzle tip is saved to the database as nozzle shape data. The attached nozzle is selected in the database and the hole diameter and length information on the tube portion at the nozzle tip is read, whereby the viscosity is determined.

The display apparatus/manual data input apparatus (MDI) 25 is connected to the bus 26 via an interface (I/F) 24 to allow selection of a function menu, operations of inputting various data, and the like. The display apparatus/MDI 25 is provided with ten keys used to input numerical data, various function keys, and the like. The display apparatus may use a liquid crystal device (LCD), a CRT, or any other display apparatus. Furthermore, the input apparatus may be a touch panel.

The injection molding machine is configured as described above. Thus, the PMCCPU 17 controls the sequence of the injection molding machine as a whole. The CNCCPU 20 distributes movement instructions to the servo motors for the respective shafts based on, for example, the operation programs in the ROM 21 and the molding conditions stored in the RAM 23 to which molding data are saved. The servo CPU 15 executes a digital servo process based on, for example, movement instructions distributed to the shafts and position and speed feedback signals detected by the position and speed detectors P1, P2, P3, P4, and P5 to controllably drive the servo motors M1, M2, M3, M4, and M5.

A molding operation using the injection molding machine M will be described. When the motor M3 for moving the movable platen forward and backward is rotated forward, the ball screw shaft 38 is rotated forward, and the crosshead 34 fitted over the ball screw shaft 38 in a threaded manner is moved forward, in other words, rightward in FIG. 4. Thus, the toggle mechanism 36 is actuated to move the movable platen 30 forward.

The movable mold 40a attached to the movable platen 30 comes into contact with the fixed mold 40b to establish a mold closed state. The process then shifts to a clamping step. In the clamping step, the motor M3 for moving the movable platen forward and backward is further driven forward to allow the toggle mechanism 36 to exert a clamping force on the mold 40. The servo motor M1 for moving the screw forward and backward, which is provided in the injection section Mi, is driven to move forward in the axial direction of the screw 3. Thus, the molten resin is filled into the cavity space formed in the mold 40. When the molds are opened, the motor M3 for moving the movable platen forward and backward is driven backward to rotate the ball screw shaft 38 backward. In conjunction with this, the cross head 34 moves backward to operate the toggle mechanism 36 in a direction in which the toggle mechanism 36 is bent. The movable platen 30 moves backward toward the rear platen 31. When the clamping step is complete, the motor M4 for moving the ejector forward and backward is actuated in order to eject the ejector pin to push a molded article out of the movable mold 40a. Thus, the ejector pin (not shown in the drawings) is ejected from an inner surface of the movable mold 40a. The molded article in the movable mold 40a is ejected out of the movable mold 40a.

In viscosity measurement according to one of the embodiments of the present invention, the clamping section Mc does not operate. The tip of the nozzle 2 installed in the heating cylinder 1 of the injection section Mi is not brought into contact with the mold 40. Then, with the molten resin emitted into the air through the nozzle 2, the pressure of the molten resin is measured by the pressure sensor attached to the nozzle adapter 60. Simultaneously with the measurement of pressure of the molten resin, measurement is performed on physical quantities such as the injection speed and the elapsed time since the start of injection which are needed to calculate the viscosity. Based on the resulting physical quantities, the viscosity is calculated.

1. An injection molding machine configured to melt a resin in a heating cylinder and then move a screw or a plunger forward to inject the molten resin through a nozzle, the injection molding machine comprising:
a nozzle adapter attached between a tip portion of the heating cylinder and the nozzle to provide a molten resin channel that connects the heating cylinder to the nozzle;
a pressure measuring unit configured to measure a resin pressure in the nozzle adapter; and
a molten resin injecting unit configured to inject the molten resin into air with a front of the nozzle open,
the injection molding machine further comprising:
a viscosity determining unit configured to determine viscosity of the injected molten resin based on the resin pressure measured by the pressure measuring unit while the molten resin injecting unit is injecting the molten resin into the air.

2. The injection molding machine according to claim 1, wherein a resin pressure measurement position in the nozzle adapter is a position closer to the nozzle than an axial position that is closest to the nozzle, among axial positions where the molten resin channel has a diameter equal to an inner diameter of a heating cylinder-side end surface.

3. The injection molding machine according to claim 1, wherein a pressure measurement position in the nozzle adapter is a cylindrical portion, of the molten resin channel, which has an inner diameter equal to an inner diameter of a nozzle-side end surface.

4. The injection molding machine according to claim 1, further comprising a storing unit configured to store a hole diameter and a length of a tube portion at a nozzle tip and a diameter of the screw or the plunger, wherein
the viscosity determining unit is configured to determine the viscosity from the resin pressure measured at a set screw position or at a set elapsed time since start of injection, an injection speed, and the stored hole diameter and length of the tube portion at the nozzle tip and the stored diameter of the screw or the plunger.

5. The injection molding machine according to claim 4, wherein information on combination of the hole diameter and the length of the tube portion at the nozzle tip is saved to a database as nozzle shape data, and the viscosity is determined by reading the information on the hole diameter and the length of the tube portion at the nozzle tip based on the attached nozzle.

6. A method for measuring resin viscosity using an injection molding machine configured to melt a resin in a heating cylinder and then moves a screw or a plunger forward to inject the molten resin through a nozzle, the method comprising:
measuring the resin pressure when the molten resin is injected into air with a front of the nozzle open, using pressure measuring unit configured to measure a resin pressure in a nozzle adapter attached between a tip portion of the heating cylinder and the nozzle to provide a molten resin channel that connects the heating cylinder to the nozzle;
determining viscosity of the injected molten resin based on the measured resin pressure.

7. The method for measuring resin viscosity using an injection molding machine according to claim 6, wherein a resin pressure measurement position in the nozzle adapter is a position closer to the nozzle than an axial position that is closest to the nozzle, among axial positions where the molten resin channel has a diameter equal to an inner diameter of a heating cylinder-side end surface.

8. The method for measuring resin viscosity using an injection molding machine according to claim 6, wherein a pressure measurement position in the nozzle adapter is a cylindrical portion, of the molten resin channel, which has an inner diameter equal to an inner diameter of a nozzle-side end surface.

9. The method for measuring resin viscosity using an injection molding machine according to claim 6, wherein the viscosity is determined from the resin pressure measured at a set screw position or at a set elapsed time since start of injection, an injection speed, a hole diameter and a length of a tube portion at a nozzle tip, and a diameter of a screw or a plunger.
